(19) United States
(12) Patent Application Publication
(10) Pub. No.: US 2006/0275625 A1
(43) Pub. Date: Dec. 7, 2006

(54) High and low refractive index and metallic surface relief coatings

(76) Inventor: Daniel Lieberman, San Diego, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/198,625

(22) Filed: Aug. 5, 2005

Related U.S. Application Data
(63) Continuation-in-part of application No. 11/144,349, filed on Jun. 3, 2005.

(51) Int. Cl. B32B 9/00; B32B 19/00

(52) U.S. Cl. 428/697; 428/689; 428/701; 428/702

(57) ABSTRACT

The present invention provides articles comprising a substrate, a high (or low) refractive index and/or metallic surface relief coating that is applied to the substrate and surface relief structures that are applied to the coating at substantially the same speeds and widths of conventional printing systems, and in substantially perfect register to conventional printing systems, thereby obviating the need for already-embossed substrates including films and hot-stamping foils.

### REFERENCE TO RELATED APPLICATIONS

This application is a Continuation-In-Part of U.S. patent application Ser. No. 11/144,349, filed Jun. 3, 2005.

### FIELD OF THE INVENTION

The present invention is directed to surface relief structures, and more particularly to, high and low refractive index and metallic surface relief coatings that are applied using conventional printing equipment.

### BACKGROUND OF THE INVENTION

Conventional holographic surface reliefs are manufactured by slow embossing and casting processes that are separate from mainstream printing processes. For example, the processes may involve embossing onto pre-metallized materials or casting onto clear films and papers, and then metallizing the embossed materials. These embossing and casting processes suffer from a number of known drawbacks, including: (1) the processes are not suitable for use with the printing equipment; (2) embossing or casting in localized regions is not possible with conventional metallizing equipment; (3) the metallizing equipment is prohibitively expensive; (4) printing onto the embossed and metallized material is very slow and expensive; (5) conventional embossing and casting systems are much slower than printing equipment; (6) it is difficult to overprint onto a holographic substrate when perfect registration is required; (7) holographic substrates may cover the entire face of the substrate, which may be a problem if the final product is a label, package or security document; and (8) holographic hot-stamping and cold-stamping substrates may have to be added to the printing in attachments placed on the conventional printing equipment.

Some prior art systems have attempted to cure some of the above-identified drawbacks by curing holograms with ultra-violet/electron beam (UV/EB) curing systems or other forms of electromagnetic radiation, and then applying vacuum evaporated aluminum onto the hologram using an online printing process. However, such systems have failed due to the difficulty of maintaining a proper vacuum for aluminum deposition in a printing process that requires an air-to-air vacuum metallizer. Additionally, these systems are very complex and expensive, and require at least two additional steps including curing the hologram and metallizing the hologram. Other prior art systems utilize process for casting nano-, micro-, and macro- structures at high speeds. However, such processes often result in surface relief distortions.

Holograms or surface relief structures may be printed such that they become reflective, semi-reflective or non-reflective in a single pass through a printing station. Reflective surface reliefs may include one or more of the following additional drawbacks. One drawback of reflective surface reliefs is that the quality of the metallic ink may not be as reflective as desired because the metallic particles that are mixed into the pigment do not properly align themselves according to the planar features of the substrate and the surface relief. Such a phenomenon is common when using UV/EB curable metallic inks. This results in a dulling of the surface relief image and leafing problems that require the application of a protective coating. Another drawback of reflective surface reliefs is that the thickness of the metallic coating diminishes the holographic effect. In vacuum metallizing, the metallic coating measures between 300 to 500 Angstroms, whereas in printing systems it is around 1 to 2 microns or more than the embossing depth of about 0.2 microns. This relatively thick coating tends to obliterate the brightness and efficiency of the surface relief.

In order for nano-, micro-, and macro- structures to become more widely used in mainstream labeling and packaging applications, it is necessary to be able to print these structures with existing printing methods. This will enable printing at high speeds, at required widths, and in register with the conventional printing on the label, package or document being printed.

Spanish patents ES 2145658 B1 and ES 2185049T3 disclose methods of linking an embossing and/or casting unit to the beginning or end of a conventional printing press. The purpose of these patents is to be able to: (1) emboss a substrate with continuous holographic surface relief structures; and (2) to print the surface relief structures in register with color stations of the printing press. However, the methods disclosed by these references suffer from a number of drawbacks. In particular, the holography is applied to the entire substrate as a continuous pattern rather than being selectively applied to the substrate as it is done on a conventional printing press. Additionally, the methods require post-metallization for metallized holography, or the application of a reflective coating on top of the surface relief. Both post metallization and the application of a reflective coating are slow and expensive processes. A further drawback of the above-identified Spanish patents is that they require a 360-degree holographic cylinder. Moreover, there is no disclosure regarding the use of different coatings having different refractive indexes for producing bright and viewable holography.

European Patent EP1150843 discloses a method and device for rotational molding of surface relief structures to a substrate using a conventional printing machine. The method comprises the steps of: applying a curable lacquer onto the substrate using a flexographic tool; pre-curing the curable lacquer; passing the substrate through a molding station; adjusting the embossing tool to the pre-cured lacquer; and post-curing the lacquer. One drawback of this patent is that the method of the invention requires two or more curing steps to cure the lacquer. Additionally, the post-curing step may create problems in the resolution of the surface features because the features will start to degrade as soon as the substrate leaves the molding station until they are 100% cured. A further drawback is that the invention does not envision the use of metallic inks and lacquers to make the structures reflective without the use of expensive vacuum metallizing equipment.

Another drawback of the above-identified European patent is that it does not disclose the use of high and low diffractive index transparent inks and lacquers in order to avoid rendering the structure invisible when it is overprinted or overlaminated. An additional drawback is that the device of the invention is based on old-fashioned gear systems rather than contemporary gearless devices. The old-fashioned gear systems use cylinders of different diameters to achieve variable printing lengths, whereas, with a gearless press it is possible to have different printing lengths without changing the diameters of the cylinders. Yet another drawback is that the preferred molding material is a transparent elastomer made of Polydimetylsiloxane (PDMS), which degrades quickly with electromagnetic radiation.

U.S. Patent Publication No. 2004/0166336 discloses the use of a metallic substrate as a base, and then coating the substrate with a transparent embossable lacquer using the reflective properties of the metal substrate. Some drawbacks of this reference are that: (1) it does not disclose the use of a high refractive layer; (2) the base substrate is metallic; (3) it involves printing in layers rather than printing in register; and (4) it does not involve applying selective holography.

Conventional systems employ coatings that are embossable with surface relief structures. Such systems may involve hard embossing, soft embossing, hybrid embossing and/or casting embossing. Typical coatings include: (1) acrylic based coatings; (2) homopolymer or copolymer coatings based on polypropylene or polyester; (3) pvdc coatings; (4) pvc coatings; (5) UV/EB curable coatings; and/or (6) other known coatings. One drawback of conventional coatings is that they require an expensive multi-step process in order to make the surface relief structures viewable. Particularly, the process may comprise the steps of: (1) applying the coating to a substrate on a coating machine; (2) embossing the coating; and (3) vacuum metallizing or sputtering using prohibitively expensive equipment. Alternatively, the process may comprise the steps of: (1) applying the coating to a substrate on a coating machine; (2) vacuum metallizing or sputtering; and (3) embossing.

Aluminum is the most commonly employed metal for the vacuum metallizing or sputtering step to produce surface relief structures having a metallic look. To produce semi-transparent surface relief structures, the amount of deposited metal (e.g., aluminum) is reduced to a suitable level. Reflective yet completely transparent surface relief structures may also be produced. However, these surface relief structures still require the use of the expensive metallizing or sputtering equipment with different coatings containing deposited metals such as aluminum, silver, gold, cobalt, nickel, chromium, and/or other suitable metals. Another drawback of conventional coating, sputtering, and metallizing techniques concerns the difficulty of producing selective areas that are metallized while leaving the surrounding areas with no metal. A further drawback involves a lack of registration between these techniques and conventional printing processes.

U.S. Patent Publication No. 2005/0063067 discloses reflective surface relief structures that are produced using surface relief and hologram technologies to create optical effects using an expensive multi-step process including: (1) applying a coating to a substrate; (2) embossing the coating; (3) pattern metallizing the coating; and (4) applying an optical coating. This multi-step process is both prohibitively expensive and extremely slow. Moreover, the invention does not contemplate the embossing and or casting of surface relief structures online in register with conventional printing methods.

In view of the above, there exists a need for systems and methods for printing surface relief structures that fully incorporates surface relief technologies into mainstream printing applications such as currency printing, flexible and rigid packaging, labels, and printed forms.

There further exists a need for systems and methods for printing surface relief structures that are incorporated onto printed substrates at the same speeds as conventional printing processes and in perfect registration to conventional printing on the same printing equipment.

### SUMMARY OF THE INVENTION

In view of the foregoing, it is an object of the present invention to provide systems and methods for printing surface relief structures that fully incorporates surface relief technologies into mainstream printing applications such as currency printing, flexible and rigid packaging, labels, and printed forms.

It is another object of the invention to provide systems and methods for printing surface relief structures that are incorporated onto printed substrates at the same speeds as conventional printing processes and in perfect registration to conventional printing on the same printing equipment.

The present invention provides articles comprising a substrate, a high (or low) refractive index and/or metallic surface relief coating that is applied to the substrate and surface relief structures that are applied to the coating at substantially the same speeds and widths of conventional printing systems, and in substantially perfect register to conventional printing systems, thereby obviating the need for already-embossed substrates including films and hot-stamping and cold-stamping foils.

### BRIEF DESCRIPTION OF THE DRAWINGS

FIG. 1A is a schematic depiction of a coating of the present invention containing metallic particles;

FIG. 1B is a schematic depiction of a coating of the present invention containing high (or low) refractive index particles;

FIG. 1C is a schematic depiction of a coating of the present invention containing both metallic particles and high (or low) refractive index particles;

FIG. 2A is a schematic depiction of a transparent coating of the present invention;

FIG. 2B is a schematic depiction of a high (or low) refractive index surface relief coating of the present invention;

FIG. 2C is a schematic depiction of a high (or low) refractive index surface relief plus metallic coating of the present invention;

FIG. 3A is a schematic depiction of a transparent coating provided with an additional coating according to the principles of the present invention;

FIG. 3B is a schematic depiction of a high (or low) refractive index surface relief coating provided with an additional coating according to the principles of the present invention;

FIG. 3C is a schematic depiction of a high (or low) refractive index surface relief plus metallic coating that is provided with an additional coating according to the principles of the present invention;

FIG. 4A is a schematic depiction of a high (or low) refractive index surface relief coating that is coated with dielectric particles in accordance with the principles of the present invention;

FIG. 4B is a schematic depiction of a retroreflective coating of the present invention;

FIG. 4C is a schematic depiction of RFID antenna hologram of the present invention;

FIGS. 5-12 depict various alternative articles of the present invention;

FIG. 13 illustrates the use of conventional printing equipment to print both conventional ink-based images and surface relief structures onto a substrate;

FIG. 14 depicts a preferred system of printing surface relief structures on a substrate using conventional printing equipment, in accordance with the principles of the present invention;

FIGS. 15A-15C are perspective views illustrating the substrate after a metallic base layer coated with a high refractive index material layer having surface relief structures is applied thereto; and

FIG. 16 depicts a preferred system of printing mirrored surface relief structures on a substrate using conventional printing equipment, in accordance with the principles of the present invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention is directed to nano-, micro-, and macro- surface relief structures featuring high refractive index surface relief (HRISR) coatings, low refractive index surface relief (LRISR) coatings, metallic inks and/or lacquers for surface relief structures that are “printed” or cast (cured) in conventional or digital printing equipment with perfect registration to the conventional printing stations to produce surface relief structures such as holograms. The coatings of the present invention include water-based coatings, solvent-based coatings and UV/EB-based coatings. Advantageously, the coatings of the present invention obviate the need for already-embossed substrates including films, hot-stamping foils and cold-stamping foils. Such already-embossed substrates are expensive and difficult to integrate with conventional printing at high speeds and proper registration.

The coatings of the present invention may have a high refractive index, a low refractive index and/or metallic particles, as well as a good release from the embossing and/or casting tools used to produce the surface relief structures. In order to keep the holography viewable on the substrate, it is important that the HRISR and/or LRISR coatings have a different refractive index from any adhesives, laminates inks and/or lacquers that are applied to the surface relief. The holography is viewable even if the difference in refractive index is quite small.

According to the preferred embodiment of the invention, nano-, micro- and macro-structures that exhibit surface reliefs of more than 10 nanometers to less than 3 millimeters in depth and width are “printed” or cast (cured) in conventional or digital printing equipment with perfect registration to the other printing stations. Such structures may be optical or non-optical in nature. For example, holograms may be printed such that they become reflective, semi-reflective or non-reflective in just one pass through the “printing” station. Some of the advancements described herein are due in part to recent developments in metallic ink technology, gearless technology, sleeve technology, electron beam technology, UV technology, and temperature control technology.

Advantageously, the surface relief structures may be printed on a substrate at substantially the same speeds and widths of conventional printing systems, and in perfect register to conventional printing systems. Additionally, the surface relief structures of the invention may be printed in any localized location of the substrate and in perfect register to the printing at other printing stations. Applications for this technology include, but are not limited to: (1) currency printing; (2) flexible packaging; (3) rigid packaging; (4) shrink wrap films; (5) labels; (6) security documents such as continuous forms; (7) retroreflective structures; (8) non-reflective structures; (9) online lenticular printing; (10) intelligent substrates such as self cleaning substrates; (11) radio frequency identification products; (12) plastic chips; (13) micro-analysis systems; (14) optical components; (15) medical applications; (16) polymer displays; (17) solar panels; (18) defense applications; and (19) radar invisibility applications.

In accordance with the principles of the present invention, a selected HRISR or LRISR coating may contain particulate matter such as metallic particles and/or high refractive index particles to make the coating highly reflective. Suitable particulate matter for producing reflective surface relief structures include, but are not limited to: (1) aluminum particles; (2) silver particles; (3) gold particles; (4) cobalt particles; (5) chromium particles; (6) platinum particles; (7) palladium particles; (8) nickel particles; (9) cobalt particles; (10) carbon particles; (11) platelets; (12) flakes; (13) dielectric particles; (14) cholesteric liquid crystal polymer particles; (15) magnetic pigment flakes; (16) holographic glitter particles; (17) aluminum oxides (e.g., AL₂O₃); (18) Ce₂O₃; (19) SnO₂; (20) B₂; (21) O₃; (22) titanium dioxide (TiO₂); (23) iron oxides (e.g., Fe₃O₄ and Fe₂O₃); (24) zirconium oxide (ZrO₂); (25) zinc oxide (ZnO); (26) zinc sulfide (ZnS); (27) bismuth oxychloride; (28) indium oxide (In₂O₃); (29) indium-tin-oxide (ITO); (30) tantalum pentoxide (Ta₂O₅); (31) ceric oxide (CeO₂); (32) yttrium oxide (Y₂O₃); (33) europium oxide (Eu₂O₃); (34) hafnium nitride (HfN); (35) hafnium carbide (HfC); (36) hafnium oxide (HfO₂); (37) lanthanum oxide (La₂O₃); (38) magnesium oxide (MgO); (39) neodymium oxide (Nd₂O₃); (40) praseodymium oxide (Pr₆O₁₁); (41) samarium oxide (Sm₂O₃); (42) antimony trioxide (Sb₂O₃); (43) silicon carbide (SiC); (44) silicon nitride (Si₃N₄); (45) silicon monoxide (SiO); (46) selenium trioxide (Se₂O₃); (47) tin oxide (SnO₂); (48) tungsten trioxide (WO₃); and (49) combinations thereof.

According to an aspect of the invention, the metallic particles within the coating are aligned substantially parallel to the base substrate, and then the coating is cured. According to the preferred embodiment of the invention, the coating is maintained at a predetermined temperature before curing in order to align the particles substantially parallel to the base substrate.

Another aspect of the present invention involves the creation of semi-transparent and metallizing effects using HRISR and LRISR coatings. Suitable particulate matter for maintaining the transparency of the coating while keeping surface relief reflective enough in order to be easily seen (even when covered by adhesives, inks, lacquers, and/or laminates) will now be described. Specifically, suitable particulate matter for producing the desired transparency include, but are not limited to: (1) titanium dioxide (TiO₂); (2) iron oxide Fe₂O₃; (3) aluminum oxide (Al₂O₃); (4) Ce₂O₃; (5) tin oxide (SnO₂); (6) boric oxide (B₂O₃); (7) titanium dioxide (TiO₂); (8) zirconium; (9) zinc oxide (ZnO); (10) zinc sulfide (ZnS); (11) bismuth oxychloride; (12) Sb₂O₅; (13) zirconium oxide (ZrO₂); (14) dielectric particles; (15) tungsten oxide (SnWO₄); (16) oxide of bismuth (BiOx); (17) bismuth oxide (Bi₂O₃); (18) titanium oxide (TiO); (19) niobium oxide (Nb₂O₅); (20) carbon; (21) indium oxide (In₂O₃); (22) indium-tin-oxide (ITO); (23) tantalum pentoxide (Ta₂O₅); (24) ceric oxide (CeO₂); (25) yttrium oxide (Y₂O₃); (26) europium oxide (Eu₂O₃); (27) Fe₃O₄; (28) hafnium nitride (HfN); (29) hafnium carbide (HfC); (30) hafnium oxide (HfO₂); (31) lanthanum oxide (La₂O₃); (32) magnesium oxide (MgO); (33) neodymium oxide (Nd₂O₃); (34) preododymium oxide (Pr₆O₁₁); (35) samarium oxide (Sm₂O₃); (36) antimony trioxide (Sb₂O₃); (37) silicon carbide (SiC); (38) silicon nitride (Si₃N₄); (39) silicon monoxide (SiO); (40) selenium trioxide (Se₂O₃); (41) tungsten trioxide (WO₃); and (42) combinations thereof.

The HRISR and LRISR coatings of the present invention may also include particulate matter for achieving high transparency. Suitable particulate matter for LRISR coatings for producing the desired high transparency include, but are not limited to: (1) silicon dioxide (SiO₂); (2) aluminum oxide AL₂O₃; (3) magnesium fluoride (MgF₂); (4) aluminum fluoride (AlF₃); (5) cerium fluoride (CeF₃); (6) lanthanum fluoride (LaF₃); (7) sodium aluminum fluorides (e.g., Na₃Al₃F₆ and Na₃Al₃F₁₄); (8) neodymium fluoride (NdF₃); (9) samarium fluoride (SmF₃); (10) barium fluoride (BaF₂); (11) calcium fluoride (CaF₂); (12) lithium fluoride (LiF); (13) monomers; (14) polymers; (15) dienes; (16) alkenes; (17) acrylates; (18) perfluoroalkenes; (19) polytetrafluoroethylene; (20) fluorinated ethylene propylene (FEP); and (21) combinations thereof In accordance with the preferred embodiment of the present invention, surface relief structures such as holograms are cast or embossed onto an HRISR or LRISR coating in a single pass. Advantageously, the surface relief structures may be metallized, semi-metallized or made transparent without the need for prohibitively expensive vacuum-metallizing or sputtering-metallizing equipment. Additionally, the HRISR and LRISR coatings of the present invention may be selected to possess optical coating properties such as magnetic properties, metallic properties and the ability to change colors. Moreover, the surface relief structures of the invention may be configured to interact with the HRISR and LRISR coatings to create innovative and improved optical effects.

In accordance with an aspect of the present invention, the HRISR and LRISR coatings allow a printer to print surface relief structures such as holography online and in register with conventional printing. Specifically, the coatings of the invention may be applied to a substrate using conventional printing equipment including, but not limited to: (1) offset printing; (2) flexographic printing; (3) rotogravure printing; (4) ink-jet printing; (5) letterpress printing; (6) digital printing; (7) silk-screen printing; (8) intaglio printing; and (10) litho printing. The HRISR or LRISR coatings preferably are applied and embossed with a surface relief at the same color station. Alternatively, the HRISR or LRISR coatings may be applied in a corresponding color station in register to a surface relief that was previously placed at a different color station.

The HRISR and LRISR coatings of the present invention allow for the embossing and or casting of myriad surface relief structures online with any of the above-identified conventional printing equipment in substantially perfect register or without register to the printing of other conventional inks and/or lacquers. Since the coatings already possess the desired visual properties (e.g., reflective, metallic, transparent, dielectric, etc.), there is no need to coat the surface relief structures with additional coatings such as reflective and dielectric layers. The holography printed on the coatings does not disappear if other materials such as adhesives, laminates and other coatings are applied to the surface relief structures.

The HRISR and LRISR coatings of the present invention may comprise: (1) dielectric coatings; (2) color shifting pigments; (3) luminescent pigments; (4) magnetic pigments; (5) security inks; (6) fluorescent pigments; and/or (7) phosphorescent pigments. A coating preferably is chosen such that various surface relief structures may be selectively applied to the final substrate in a single pass. The coating may contain color shifting properties, magnetic properties, dielectric properties, and other properties. Additionally, any of the above-identified pigments and coatings may be mixed with microspheres in order to make the pigments brighter.

The coatings of the present invention are adapted to receive embossed or cast surface relief structures including, but not limited to: (1) holograms; (2) optical variable devices; (3) gratings; (4) computer generated holograms; (5) ebeam generated structures; (6) dot matrix holograms; (7) dot matrix stereograms; (8) retroreflective structures (e.g., corner cubes); (9) nanostructures; (10) microstructures; (11) micro fluidic structures; (12) micro electronic circuits; (13) moire patterns; (14) radio frequency identification (RFID) antennas; (15) lenticular lenses; (16) lenses; (17) self cleaning structures; (18) moth-eye structures; and (19) combinations of these structures.

Referring to FIG. 1A-1C, the coatings of the present invention may contain various combinations of particulate matter. For example, the coating of FIG. 1A contains metallic particles such that the coating is reflective. Although this coating lacks high (or low) refractive index particles, it may be used in connection with surface relief structures. On the other hand, the coating of FIG. 1B contains high (or low) refractive index particles, but lacks metallic particles. Although this coating does not contain metallic particles, it is reflective enough in order to see surface relief structures disposed on one of its surfaces. The coating of FIG. 1C contains both metallic particles and high (or low) refractive index particles. Advantageously, this coating will produce very bright surface relief structures. In addition, depending on the density of the metallic particles, the coating may be solid, transparent or semi-transparent.]

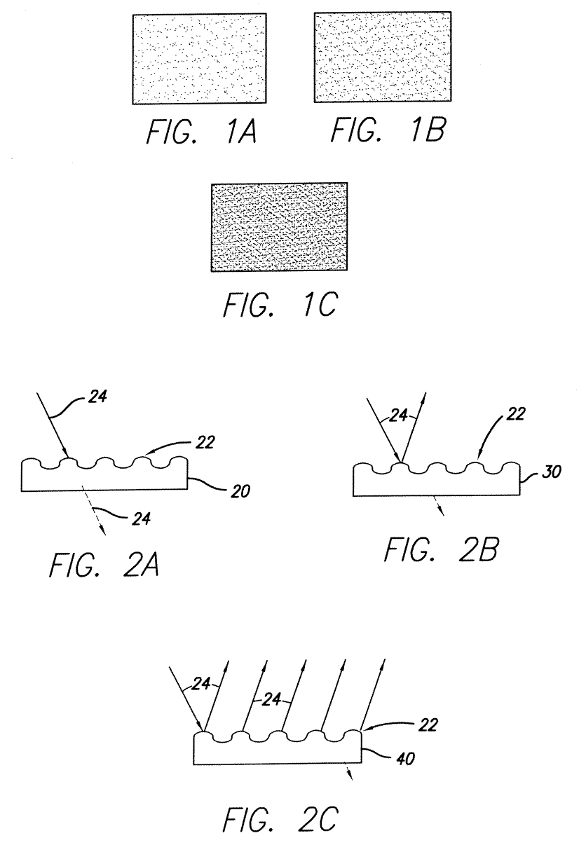

FIG. 2A depicts a transparent coating 20 with surface relief structures 22 applied thereto. In this case, surface relief structures 22 appear very dim since there is limited reflection of light 24. Instead, most of the light passes through transparent coating 20. FIG. 2B depicts an HRISR coating 30 having surface relief structures 22. Alternatively, coating 30 may comprise an LSISR coating. Since the coating has a high refractive index, a high percentage of light 24 is reflected, thereby making surface relief structures 22 more viewable. FIG. 2C depicts an HRISR and metallic coating 40 having surface relief structures 22. The metallic particles within coating 40 will help reflect an even higher percentage of light 24 such that the surface relief structures are highly visible to a human eye.

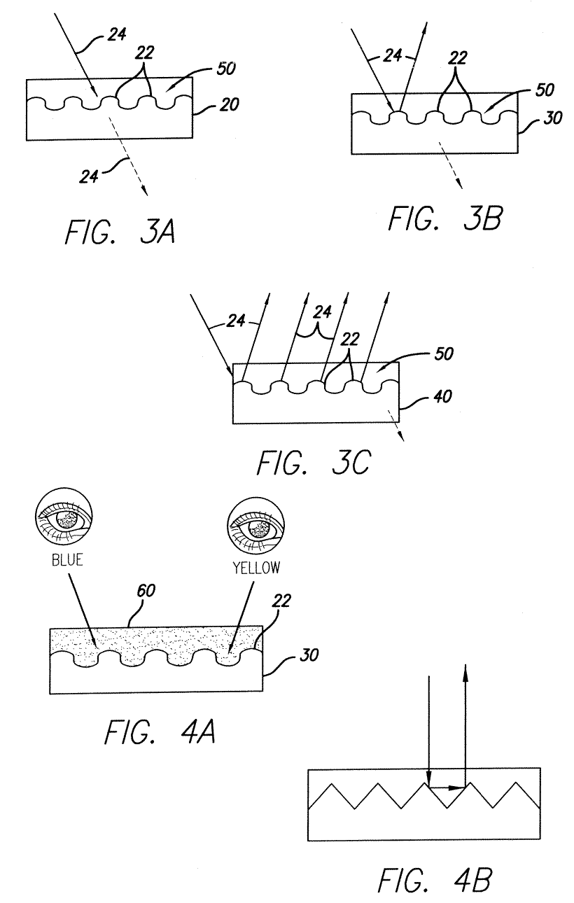

FIG. 3A depicts a transparent coating 20 with surface relief structures 22 applied thereto. When a second coating 50 is applied on top of the surface relief structures, they become invisible because virtually all of the light 24 passes through transparent coating 20. By way of example, second coating 50 may comprise various adhesives, inks, lacquers or laminates. FIG. 3B depicts an HRISR coating 30 having surface relief structures 22. Alternatively, coating 30 may comprise an LSISR coating. After the second coating 50 is applied on top of the surface relief structures, they remain visible since coating 30 has a high refractive index. FIG. 3C depicts an HRISR and metallic particle coating 40 having surface relief structures 22. After the second coating 50 is applied, surface relief structures 22 remain highly visible since coating 40 has a high refractive index and the metallic particles within coating 40 help reflect an even higher percentage of light 24.

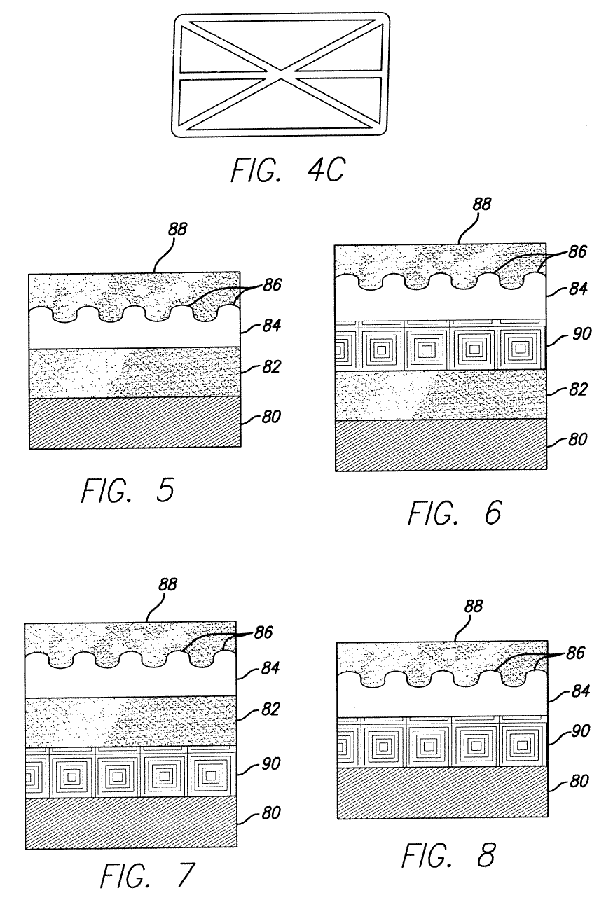

Referring to FIG. 4A, HRISR coating 30 having surface relief structures 22 is coated with a second coating 60 containing dielectric particles such that different hues are viewable at different viewing angles. Alternatively, coating 30 may comprise an LSISR coating. In addition, the surface relief effects are viewable at the same time. FIG. 4B depicts an HRISR and metallic particle coating 40 having a retroreflective surface relief structure 62 such that most light 24 is reflected back in substantially the opposite direction as it approached the surface relief structure. In the illustrated embodiment, retroreflective surface relief structure 62 is a corner cube structure. FIG. 4C depicts an RFID antenna 70 comprising an HRISR or LRISR coating with metallic particles such that the resultant structure comprises a holographic antenna. Alternatively, RFID antenna 70 may comprise and HRISR coating on top of a metallic coating such as a hot-stamping metallic foil, cold-stamping metallic foil or metallic ink.

FIGS. 5-12 depicts various surface relief structures capable of being produced by applying the principles of the present invention, wherein similar elements have been numbered accordingly. Referring to FIG. 5, a substrate 80 is selectively coated with a metallic coating 82 such as a hot-stamping metallized foil, a cold-stamping metallized foil, metallic inks or metallic lacquers. In addition, an HRISR or LRISR coating 84 having embossed surface relief structures 86 on top of metallic coating 82, and then coating 88 is applied on top of the metallic coating. Coating 88 may comprise a protective or printed layer such as an ink, lacquer, adhesive or laminate. Referring to FIG. 6, substrate 80 is again selectively coated with a metallic coating 82 such as a hot-stamping metallized foil, a cold-stamping metallized foil, metallic inks or metallic lacquers. Then, a printed layer 90 is applied on top of metallic coating 82, and HRISR or LRISR coating 84 having embossed surface relief structures 86 is applied on top of printed layer 90. A coating 88 such as a protective or printed layer is then applied on top of the HRISR coating.

Referring to FIG. 7, printed layer 90 is applied directly on top of substrate 80, and then metallic coating 82 is applied on top of printed layer 90. HRISR or LRISR coating 84 having surface relief structures 86 is applied on top of metallic coating 82, and then coating 88 such as a protective or printed layer is then applied on top of the HRISR coating. Referring to FIG. 8, printed layer 90 is again applied directly on top of substrate 80, however this embodiment does not feature a metallic coating. Instead, HRISR or LRISR coating 84 is applied directly on top of printed layer 90 and coating 88 (e.g., a protective or printed layer) is then applied on top of HRISR coating 84. The resultant holographic structure will appear semi-transparent such that the holography and printing are visible.

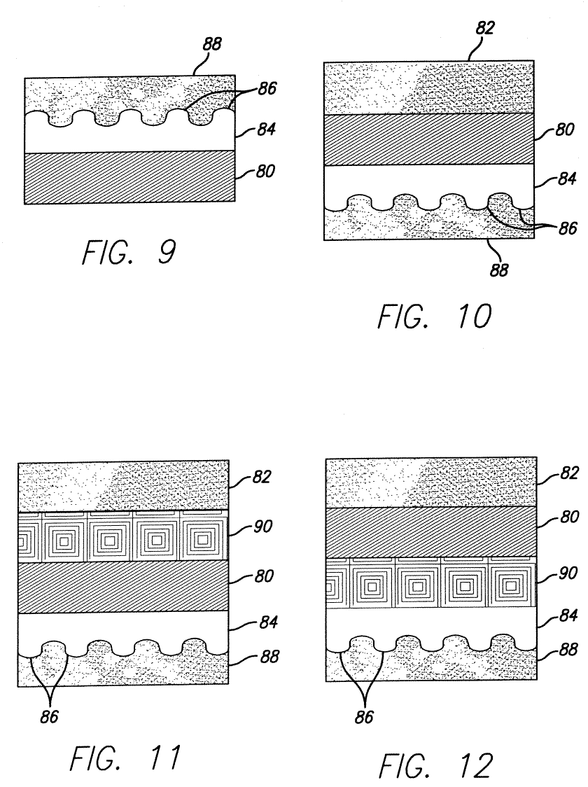

Referring to FIG. 9, HRISR or LRISR coating 84 having surface relief structures 86 is applied directly on top of the substrate 80, an then coating 88 is applied over the surface relief structures. This embodiment is a basic see-through hologram without a printed layer and a metallic layer. However, the surface relief structures remain visible due to the high refractive nature of HRISR coating 84. Referring to FIG. 10, HRISR or LRISR coating 84 is reversed printed onto one side of substrate 80, whereas metallic coating 82 is applied to the opposite side of the substrate. Coating 88 (e.g., a protective layer such as an ink, lacquer, adhesive and/or laminate) is applied on top of the HRISR coating.

Referring to FIG. 11, HRISR or LRISR coating 84 is reversed printed onto one side of substrate 80, whereas printed layer 90 and metallic coating 82 are applied to the opposite side of the substrate. The HRISR or LRISR coating includes surface relief structures 86. Again, coating 88 (e.g., a protective ink, lacquer, adhesive or laminate) is applied on top of the HRISR coating. Referring to FIG. 12, metallic coating 82 is applied to one side of substrate 80, whereas printed layer 90 is applied to the opposite side of the substrate. HRISR or LRISR coating 84 is then applied on top of the printed layer and coating 88 is applied on top of the HRISR coating.

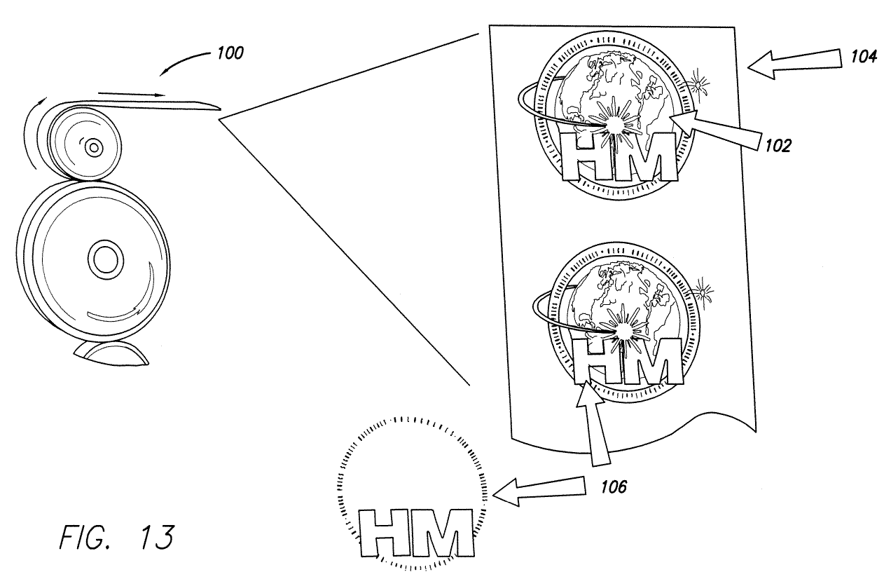

Referring to FIG. 13, conventional printing equipment 100 is used to print conventional ink-based images 102 onto a substrate 104. In accordance with the principles of the present invention, conventional printing equipment 100 is also used to print surface relief structures 106 onto substrate 104. Surface reliefs 106 can be printed on many different types of substrates, including, but not limited to: (1) plastic film; (2) paper; (3) synthetic paper; (4) boards; (5) aluminum foil; and (6) metallic sheets. Depending upon the type of substrate and coatings employed, surface relief structures 106 may be reflective, partially reflective or non-reflective. Additionally, the surface reliefs may be cast or cured with any type of UV/EB substances, such as: (1) metallic ink; (2) transparent ink; (3) dielectric ink and/or lacquer; (4) pearlecent ink and/or lacquer; (5) thermochromic ink and/or lacquer; (6) conductive ink and/or lacquer; (7) ink made with holographic powder; and (8) other types of UV/EB-based substances for creating visual effects and security applications.

In accordance with the preferred embodiment of the invention, any of the above-identified UV/EB surface relief structures may be coated with a HRISR or LRISR coating to create a wide range of structures for labeling, packaging and security applications. By way of example, the coatings of the present invention may be used for printing: (1) currency; (2) security labels; (3) security documents; (4) travel checks; (5) driver licenses; (6) passports; (7) visas; (8) government documents; (9) tags; (10) packaging; and (11) many other labeling, packaging and security applications. The HRISR, LRISR and metallic coatings described herein may comprise high refractive index solvent based, water based, and UV/EB inks and/or lacquers. Transparent curable ink may be applied on top of, or below, an HRISR or LRISR coating. The use of high or low refractive index transparent inks and lacquers prevents the resulting structure from becoming invisible when overprinted or overlaminated.

Many nano-, micro-, and macro-structures include surface reliefs that are reflective. Holograms are one example of a reflective surface relief, which requires expensive metallizing equipment that is difficult to integrate with conventional printing systems. In addition, the manufacturing rate of reflective surface reliefs is traditionally extremely slow. According to an aspect of the invention, a radiation curable coating that incorporates reflective particles is applied to nano-, micro- and macro-structures in a single pass rather than two separate operations. A suitable radiation curable coating is a UV/EB ink or lacquer comprising: (1) metallic particles or flakes that become aligned substantially parallel to the surface of the substrate upon curing; and (2) a high or low refractive index coating mixed with the particles to brighten the nano-, micro-, and macro-structures. The resultant structures will reflect light and feature a metallic appearance.

Metallic high or low refractive inks, lacquers, and other metallic coatings preferably are used in the UV/EB curing applications of the present invention in order to make the resulting structures reflective. Particularly, the metallic coating is cured while the substrate is wrapped against a surface relief tool, thereby increasing the speed and efficiency of the curing process. When using an electron beam curing process, the composition of the substrate will not affect the ability of the electrons to pass through the substrate to cure the metallic coating.

The surface relief tool includes a surface relief that is substantially leveled such that there are no raised areas. The surface relief tool preferably includes localized surface reliefs on its area that may be identical to each other or different from each other. According to some embodiments of the invention, the surface relief tool is attached to a chilled drum. The surface relief tool may comprise a nickel sleeve, a nickel plate, an etched metallic drum, a clear plastic film or a clear plastic plate.

The metallic HRISR or LRISR coating will conform to the surface relief on the embossing tool, thereby making a substantially exact copy of the surface relief features at high speed. Therefore, it is not necessary to emboss or cast the hologram at a first station and then apply the reflective or refractive coating at a second station. Advantageously, both the embossing/casting step and the application of the coating step are accomplished in one pass at a single station.

According to another aspect of the invention, a chilling station is used to help cure the UV/EB metallic coating against the surface relief tool in a single curing step. The resulting decrease in curing temperature prevents substrate and surface relief distortions that are common when using prior art systems. Particularly, it is important to be able to control temperatures in the process rollers to permit proper curing of surface relief with minimal distortion of the surface relief and the substrate to which the surface relief is attached.

According to an additional aspect of the invention, surface relief technology is provided that is compatible with reverse printing techniques that are widely used in the printing industry. One advantage of reverse printing is that the ink is protected because it never exposed. Electron beam curable equipment for reverse printing has come down in price considerably in recent years, such that it is economically feasible to install this technology on printing equipment for printing continuous forms, flexible packaging materials, rigid packaging materials, labels, and other printed products.

Due to advances in gearless press technology, it is possible to have substantially perfect registration among multiple print stations without the use of obsolete registration systems such as registration compensators. Gearless systems facilitate the installation of such a UV/EB station in printing systems, such as including: (1) flexographic equipment; (2) rotogravure equipment; (3) offset equipment; (4) continuous form equipment; (5) digital printing equipment; (6) silkscreen equipment; (7) lithographic equipment; (8) letterpress equipment; and (9) ink jet printing.

The preferred printing machine for printing surface reliefs in accordance with the principles of the invention comprises a gearless machine that ensures substantially perfect registration between printing stations and the curing tool station. Each roller in the printing machine preferably is controlled by a servomotor that is operated using a programmable logic controller, such that each roller is substantially perfectly synchronized and in register with the other rollers. With a gearless machine, it is possible to have different printing lengths without changing the diameters of the cylinders. Although the preferred printing equipment of the present invention is gearless, it should be evident to one of ordinary skill in the art that the invention may be practiced using gear presses without departing from the scope of the invention.

According to some embodiments of the invention, the thickness of the metallic coating may be varied along a continuum from very thin to very thick, depending upon the desired effect of the end product. Advantageously, the variable-thickness feature of the invention permits the creation of see-through holograms for packaging and security applications.

According to an additional aspect of the invention, nano-, micro-, and macro-structures are capable of being printed using conventional printing methods, thus enabling printing at high speeds, at required widths, and in register with any conventional printing on the document or label being printed. Such structures include, but are not limited to: (1) electron beam generated holograms; (2) dot matrix holograms; (3) computer generated holograms; (4) optically variable devices (OVDs); (5) diffractive optical variable devices (DOVDs); (6) lenses; (7) lenticular lenses; (8) non-reflective structures; (9) light management structures; (10) deep structures (e.g., structures that diffract only one wavelength at a very wide viewing angle, such as found in some butterflies and other insects); (11) radio frequency identification (RFID) antennas; (12) embossable computer chips; (13) retroreflective structures; (14) metallic-looking structures; (15) wood textures; (16) leather textures; and (17) textile textures.

According to a preferred implementation of the invention, flexographic printing equipment is employed to apply the curable coating to the substrate. Alternatively, rotogravure equipment, offset equipment, continuous form equipment, digital printing equipment, letterpress equipment, ink jet equipment and other systems may be employed to apply the curable coating. Additionally, metallic or non-metallic high-diffractive index inks or lacquers are used instead of vacuum deposited aluminum.

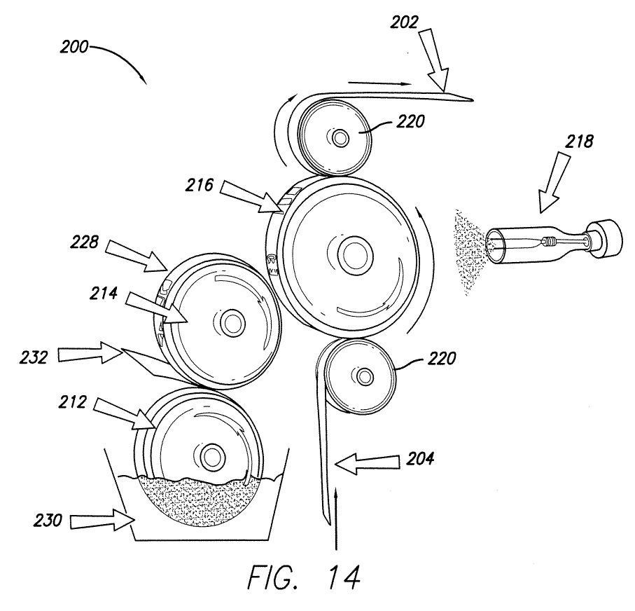

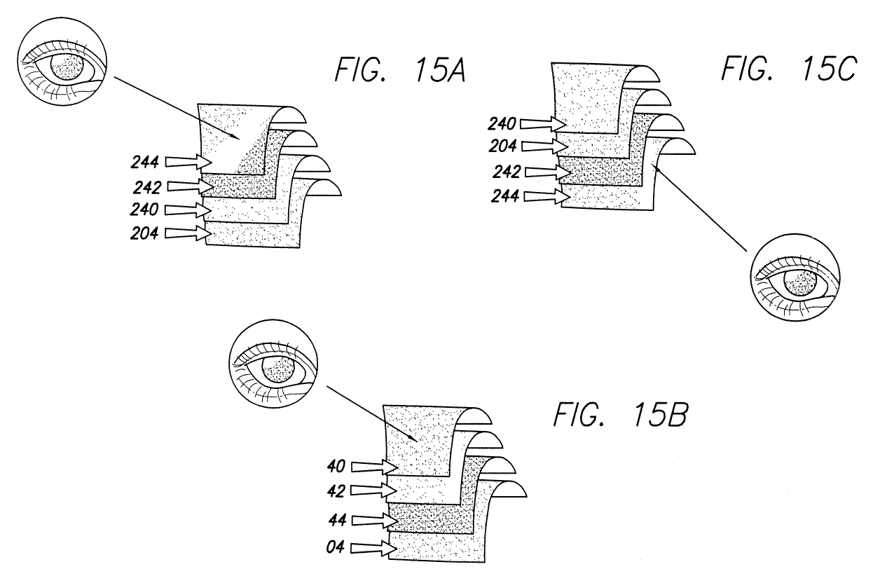

Referring to FIG. 14, a preferred system 200 of printing surface relief structures 202 on substrate 204 using conventional printing equipment will now be described. The system 200 comprises anilox roller 212, flexographic tool 214, surface relief tool 216, curing tool 218 and printing rollers 220. Flexographic tool 214 preferably comprises a flexographic printing sleeve or plate attached to a master roller that is chilled to a predetermined temperature. The flexographic tool facilitates the transfer of complex shapes (raised sections 228) onto surface relief tool 216. Raised sections 228 substantially comprise an exact copy and location of the sections on surface relief tool 216 where the surface relief structures are placed. For example, flexographic tool 214 may include raised areas 228 provided with a metallic HRISR or LRISR coating for transferring the topography of raised areas 228 onto precise sections of surface relief tool 216. The creation of raised sections on the surface relief tool itself would be far more difficult and expensive.

The system 200 further comprises a temperature-controlled tray 230 for the high or low refractive index material that forms the coating. Temperature-controlled tray 230 is designed to feed anilox roller 212, which carries the high or low refractive index material onto flexographic tool 214. The raised features of flexographic tool 214 pick up the high or low refractive index material from anilox roller 212. A doctor blade 232 may be provided for wiping excess ink away from raised areas 228 of flexographic tool 214. One advantage of using an HRISR or LRISR coating is that an adhesive, ink or additional coating may be applied to the cured coating without making the image disappear or become dimmer or distorted, regardless of the refractive index of the adhesive, ink or additional coating. A further advantage of using an HRISR or LRISR coating is that such a coating enhances the holography since it inherently reflects more light than a conventional thin clear coating, thereby increasing the brightness and definition of the resultant holographic image.

Anilox roller 212 is maintained at the predetermined temperature in order to induce the metallic particles within the high or low refractive index material to align substantially parallel to the major surface of the substrate. Anilox roller 212 may be heated or chilled depending on the printing configuration needed for a specific substrate. For example, anilox roller 212 may be heated to help the metallic particles in the metallic coating accommodate before curing. In addition, the master roller to which the flexographic sleeve is attached may be heated in order to preserve a selected temperature before curing.

In operation, raised areas 228 on flexographic tool 214 deposit the HRISR or LRISR coating onto the surface of surface relief tool 216 in substantially perfect register to the surface reliefs in surface relief tool 216. The substrate is fed between surface relief tool 216 and printing rollers 220 such that substrate 204 is pressed against surface relief tool 216. Thus, the HRISR or LRISR coating is pressed against surface relief tool 216 as it is being cured in a single pass by curing tool 218. According to a preferred implementation of the invention, curing tool 218 provides electromagnetic radiation, such as ultra-violet radiation treated with a beam of high energy electrons (UJV/EB), for cuing the coating in a single pass. As would be understood by those of ordinary skill in the art, other types of electromagnetic radiation may be used for curing the coating in a single pass without departing from the scope of the present invention.

Surface relief tool 216 comprises localized areas having surface relief features that correspond with a very high degree of precision to the location of the areas of refractive index material on flexographic tool 214. The surface relief tool may comprise a nickel surface relief sleeve, a nickel plate and/or a clear embossed plastic plate that is attached to a chilled casting roller in order to maintain the substrate at a predetermined temperature, which is selected based on the type of substrate being employed as well as the process speed. If the surface relief tool is a sleeve, the chilled casting roller is slid into the sleeve, whereas if the surface relief tool is a plate, the chilled casting roller is clamped to the plate. Advantageously, the chilled casting roller ensures that the surface relief tool imparts a substantially exact copy of the surface relief onto the substrate, at room temperature with no major distortions to either the substrate or the surface relief. Curing tool 218 cures the coating in a single pass as the substrate is pressed against surface relief tool 216.

According to some embodiments of the invention, the printing on the substrate overlaps the surface relief in substantially perfect register. According to other embodiments of the invention, the printing on the substrate does not overlap the surface relief pattern. According to further embodiments, the printing and/or surface relief may be provided as a continuous wallpaper pattern with no registration requirement. Additionally, the printing and/or surface relief may be printed on either major surface of the substrate.

The HRISR-or LRISR coating within temperature-controlled tray 230 may include metal particles for producing a metallic coating. Aluminum is one suitable material for the metal particles. When curing the metallic coating, the metal particles must be aligned substantially parallel to the substrate or the product will not be reflective. In order to correctly align the particles, the metallic coating is heated to a predetermined temperature that allows the particles to settle substantially parallel to the substrate, such that the particles follow the contour of the surface relief. As discussed hereinabove, the metallic coating is cured using curing tool 218 while substrate 204 is being pressed against surface relief tool 216 by printing rollers 220. Once cured, the metallic coating is adhered to substrate 204, which is easily separated from surface relief tool 216. The substrate will then exhibit surface reliefs that are a substantially exact copy of the surface reliefs on surface relief tool 216.

Many prior art holography systems rely on applying a metallic hot-stamping foil, hard embossing using both heat and pressure. The preferred system of printing surface reliefs structures of the present invention includes a number of advantages over such prior art systems. One advantage of the system of the present invention is that there is no external heat or pressure source required. A further advantage is that there is no visible distortion of the substrate and no visible loss of resolution of original image, when using the system of the present invention. An additional advantage involves the creation of brighter image than conventional systems. Moreover, the system of the invention involves minimal wear and tear of the surface relief tool, as compared with prior art systems.

Referring to FIG. 15A, according to a preferred embodiment of the invention, a metallic base layer 240 (e.g., a metallic coating, hot-stamp metallic foil or cold-stamp metallic foil) is initially applied to substrate 204. Then, metallic base layer 240 is coated with a high refractive index material layer 242 having surface relief structures 244. After curing, the resultant surface relief structure will have an image featuring excellent brightness and definition. Metallic base layer 240 may be used in conjunction with a transparent HRISR or LRISR coating. Particularly, metallic base layer 240 is applied to the substrate, and then the transparent HRISR or LRISR coating with the holographic structure is cured on top of the metallic coating. Advantageously, the transparent HRISR or LRISR coating is conducive to both printing and reverse printing the holography and inks. Referring to FIG. 15B, according to an alternative embodiment of the invention, high refractive index material layer 242 having surface relief structures 244 is initially cured onto the substrate, and then metallic base layer 240 is applied on top of high refractive index material layer 242. The resultant surface relief structure will be visible with excellent brightness and definition.

Similar to the embodiment of FIG. 15A, a transparent HRISR or LRISR coating may be employed as layer 242. The resultant image is visible in reverse printing with excellent brightness and sharpness characteristics. Referring to FIG. 15C, according to another alternative embodiment of the invention, metallic base layer 240 is applied to one major surface of substrate 204. The opposite major surface of substrate 204 is coated with a high refractive index material layer 242 having surface relief structures 244. The metallic ink is cured in a similar manner as the surface relief structures are cured. More particularly, the metallic ink and surface relief structures are cured by wrapping the substrate against the embossing tool, and then curing the metallic ink and surface relief structures through the substrate.

Another method for producing reflective surface relief structures involves: (1) applying metallic ink and or lacquer that it is cured against a mirror finish chilled roller at a first station; and (2) applying a high reflective index ink and/or lacquer that is cured on top of the mirror finish at a second station. Particularly, since the roller has a mirror finish, the metallic ink will become a mirror finish as well. Any type of texture in the macro relief may be imparted onto the mirror finish flexographic roller, and any type of texture may be imparted onto the metallic UV/EB inks (e.g., brushed films, polished aluminum surfaces and engraved stamping dies). The imparting of texture may be used in the production of labels, packaging, shrinkable films, greeting cards, and other products. The application of texture to the mirror finish may require the use of an additional curing tool.

Alternatively hot-stamping metallized foils, cold-stamping metallized foils and metallic inks may be used as the mirror base at the first station, and then the high reflective index ink and/or lacquer is cast and applied onto the already placed metallic finish. The hot-stamping is applied at the first station with a hot-stamping rotary attachment using heat and pressure, whereas the cold-stamping is applied on the first station by first applying a cold stamping adhesive and laminating the foil to it. In either case, the foils are applied to the surface of the substrate in the exact shape and location that the holography will have on top of them.

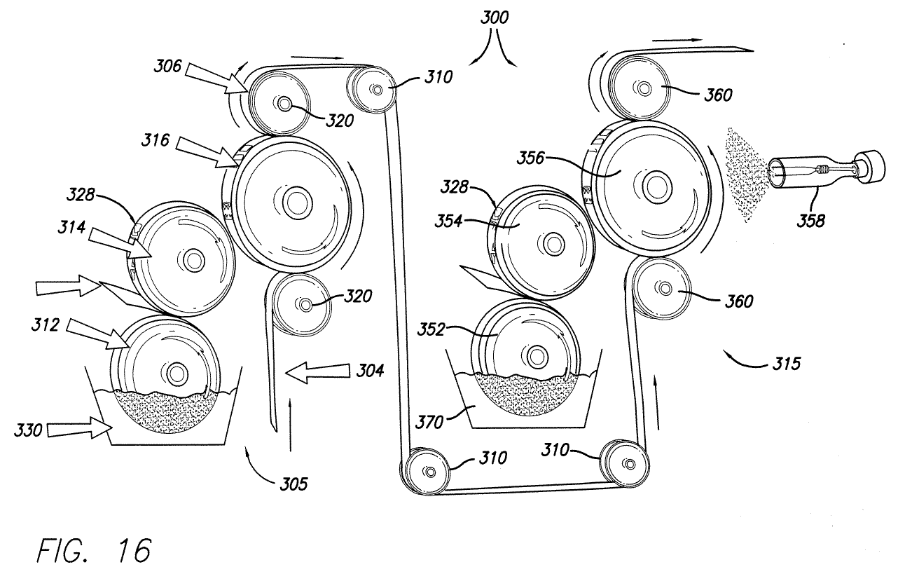

Referring to FIG. 16, a preferred system 300 of printing mirrored surface relief structures on a substrate 304 using conventional printing equipment will now be described. The system 300 comprises a first printing station 305 for applying a mirrored finish 306 to substrate 304, and a second printing station 315 for curing surface relief structures 328 on top of mirrored finish 306. The first and second printing stations are interconnect by a web including substrate 304 and rollers 310. First printing station 305 comprises anilox roller 312, flexographic tool 314, temperature controlled mirror finish roller 316, printing rollers 320 and temperature-controlled tray 330, whereas second printing station 315 comprises anilox roller 352, flexographic tool 354, surface relief tool 356, curing tool 358, printing rollers 360 and temperature-controlled tray 370.

Flexographic tools 314, 354 preferably each comprise a flexographic printing sleeve or plate attached to a master roller that is temperature controlled to a predetermined temperature. Flexographic tool 354 facilitates the transfer of complex shapes (raised sections 328) onto surface relief tool 356. Temperature-controlled tray 330 is designed to feed anilox roller 312, which carries metallic ink that will be cured against mirror finish roller 316. Temperature-controlled tray 370 is designed to feed anilox roller 352, which carries a high refractive index material onto flexographic tools 314, 354, respectfully. In operation, raised areas 328 on flexographic tool 354 deposit the HRISR or LRISR coating onto the surface of surface relief tool 356 in substantially perfect register to the surface reliefs in surface relief tool 356. The substrate is fed between surface relief tool 356 and printing rollers 360 such that the HRISR or LRISR coating is pressed against surface relief tool 356 as it is being cured by curing tool 358.

The system of FIG. 16 may be used for “pad printing” or tampography, wherein a metallic base is applied at the first station, and a surface relief structure with a refractive index coating is applied at the second station. The use of pad printing or tampography allows the surface relief structures to be imparted onto objects having intricate shapes. Otherwise, the surface relief structures may only be imparted on substantially flat substrates.

Shrinkable films tend to be extremely sensitive to heat, tension, and pressure. A further application of the principles of the present invention concerns the production of shrinkable films having print and holography that are in register, without causing the films to shrink and/or distort. In some prior art systems, the holography is transferred to the shrinkable film using a transfer process. By contrast, in accordance with the principles of the present invention, the film is printed using conventional printing equipment. Specifically, at a first printing station, a metallic coating is applied to a substrate, and at a second printing station, the holographic structure is cured on top of the metallic surface using a high refractive index lacquer. Alternatively, other metallic or non-metallic HRISR and LRISR coatings may be employed instead of the high refractive index lacquer.

Thus, it is seen that systems and methods for printing surface relief structures are provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

What is claimed is:

1. An article, comprising:
a substrate;
a high refractive index surface relief coating that is applied to the substrate; and
surface relief structures that are applied to the coating at substantially the same speeds and widths of conventional printing systems, and in substantially perfect register to conventional printing systems, thereby obviating the need for already-embossed substrates including films, hot-stamping foils and cold-stamping foils.

2. The article of claim 1, wherein the coating is selected from the group consisting of water-based coatings; solvent-based coatings; and UV/EB-based coatings.

3. The article of claim 1, wherein the surface relief structures exhibit surface reliefs of more than 10 nanometers to less than 3 millimeters in depth and width.

4. The article of claim 1, wherein the coating contains particles to make the coating highly reflective.

5. The article of claim 4, wherein the particles are selected from the group consisting of: aluminum particles; silver particles; gold particles; cobalt particles; chromium particles; platinum particles; palladium particles; nickel particles; cobalt particles; carbon particles; platelets; flakes; dielectric particles; cholesteric liquid crystal polymer particles; magnetic pigment flakes; holographic glitter particles; aluminum oxides (e.g., AL₂O₃); Ce₂O₃; SnO₂; B₂; O₃; titanium dioxide (TiO₂); iron oxides (e.g., Fe₃O₄ and Fe₂O₃); Zirconium oxide (ZrO₂); zinc oxide (ZnO); zinc sulfide (ZnS); bismuth oxychloride; indium oxide (In₂O₃); indium-tin-oxide (ITO); tantalum pentoxide (Ta₂O₅); ceric oxide (CeO₂); yttrium oxide (Y₂O₃); europium oxide (Eu₂O₃); hafnium nitride (HfN); hafnium carbide (HfC); hafnium oxide (HfO₂); lanthanum oxide (La₂O₃); magnesium oxide (MgO); neodymium oxide (Nd₂O₃); praseodymium oxide (Pr₆O₁₁); samarium oxide (Sm₂O₃); antimony trioxide (Sb₂O₃); silicon carbide (SiC); silicon nitride (Si₃N₄); silicon monoxide (SiO); selenium trioxide (Se₂O₃); tin oxide (SnO₂); tungsten trioxide (WO₃); and combinations thereof

6. The article of claim 1, wherein:
the coating contains metallic particles that accommodate substantially parallel to the surface of the substrate to make the coating more reflective; and
the coating is maintained at a predetermined temperature before curing in order to align the metallic particles substantially parallel to the substrate.

7. The article of claim 1, wherein the coating contains particles for maintaining the transparency of the coating while keeping the surface relief structures reflective enough in order to be easily seen by a human eye.

8. The article of claim 7, wherein the particles are chosen from the group consisting of: titanium dioxide (TiO₂); iron oxides Fe₂O₃; aluminum oxide (Al₂O₃); Ce₂O₃; tin oxide (SnO₂); boric oxide (B₂O₃); titanium dioxide (TiO₂); zirconium; zinc oxide (ZnO); zinc sulfide (ZnS), bismuth oxychloride; (Sb₂O₅); zirconium oxide (ZrO₂); dielectric particles; tungsten oxide (SnWO₄); oxide of bismuth (BiOx); bismuth oxide (Bi₂O₃); titanium oxide (TiO); niobium oxide (Nb₂O₅); carbon; indium oxide (In₂O₃); indium-tin-oxide (ITO); tantalum pentoxide (Ta₂O₅); ceric oxide (CeO₂); yttrium oxide (Y₂O₃); europium oxide (Eu₂O₃); Fe₃O₄; hafnium nitride (HfN); hafnium carbide (HfC); hafnium oxide (HfO₂); lanthanum oxide (La₂O₃); magnesium oxide (MgO); neodymium oxide (Nd₂O₃); preododymium oxide (Pr₆O₁₁); samarium oxide (Sm₂O₃); antimony trioxide (Sb₂O₃); silicon carbide (Sic); silicon nitride (Si₃N₄); silicon monoxide (SiO); selenium trioxide (Se₂O₃); tungsten trioxide (WO₃); and combinations thereof

9. The article of claim 1, wherein the surface relief structures are cast or embossed onto the coating in a single pass.

10. The article of claim 1, wherein the coating possesses good release characteristics from an embossing tool.

11. The article of claim 1, wherein the coating interacts with the surface relief structures to create new optical, electric and magnetic effects.

12. The article of claim 1, wherein the coating and surface relief structures are used for an application selected from the group consisting of: (1) currency printing; (2) flexible packaging, (3) rigid packaging, (4) shrink wrap films; (5) labels; (6) security documents such as continuous forms; (7) retroreflective structures; (8) non-reflective structures; (9) online lenticular printing; (10) intelligent substrates such as self cleaning substrates; (11) radio frequency identification products; (12) plastic chips; (13) micro-analysis systems; (14) optical components; (15) medical applications; (16) polymer displays; (17) solar panels; (18) defense applications; and (19) radar invisibility applications.

13. The article of claim 1, wherein the coating has a thickness between 0.1 microns and 3 mm.

14. The article of claim 1, wherein the coating has a minimal difference in refractive index with respect to any adhesives, laminates, inks and/or lacquers that are applied on top of the coating.

15. The article of claim 1, wherein the surface relief structures are applied on a surface of the coating or on a separate ink or lacquer that will be covered with the coating.

16. The article of claim 1, wherein the coating contains metallic particles to create metallizing effects with the surface relief structures.

17. The article of claim 1, wherein the coating contains metallic particles to create semi-transparent and metallizing effects with the surface relief structures, wherein the type of effects is dependent upon the particle density.

18. The article of claim 1, wherein the coating contains particles that are distributed substantially uniformly along a thickness of the coating.

19. The article of claim 1, wherein the coating is applied to a substrate selected from me group consisting of: films; papers; metals; boards; ceramics; and synthetic papers.

20. The article of claim 1, wherein the coating is applied on top of a metallic coating, a metallic ink, a metallized hot-stamping foil, or a metallized cold-stamping foil.

21. The article of claim 1, wherein the coating is applied to airborne or marine borne vessels in order to impart defense characteristics to these vessels such as radar invisibility.

22. The article of claim 1, wherein the surface relief structures are selected from the group consisting of: holograms; optical variable devices; gratings; computer generated holograms; ebeam generated structures; dot matrix holograms; dot matrix stereograms; retroreflective structures (e.g., corner cubes); nanostructures; microstructures; micro fluidic structures; micro electronic circuits; moire patterns; radio frequency identification (RFID) antennas; lenticular lenses; lenses; self cleaning structures; moth-eye structures; and combinations of these structures.

23. The article of claim 1, wherein the coating is solvent based, water based, or UV/EB curable.

24. The article of claim 1, wherein the coating contains materials selected from the group consisting of: dielectric coatings; color shifting pigments; luminescent pigments; magnetic pigments; security inks; fluorescent pigments; and phosphorescent pigments.

25. An article, comprising:
a substrate;
a low refractive index surface relief coating that is applied to the substrate; and
surface relief structures that are applied to the coating at substantially the same speeds and widths of conventional printing systems, and in substantially perfect register to conventional printing systems, thereby obviating the need for already-embossed substrates including films, hot-stamping foils and cold-stamping foils.

26. The article of claim 25, wherein the coating contains particles for maintaining the transparency of the coating while keeping the surface relief structures reflective enough in order to be easily seen by a human eye.

27. The article of claim 26, wherein the particles are chosen from the group consisting of titanium dioxide (TiO₂); iron oxide Fe₂O₃; aluminum oxide (Al₂O₃); Ce₂O₃; tin oxide (SnO₂); boric oxide (B₂O₃); titanium dioxide (TiO₂); zirconium; zinc oxide (ZnO); zinc sulfide (ZnS); bismuth oxychloride; Sb₂O_{5,}; zirconium oxide (ZrO₂); dielectric particles; tungsten oxide (SnWO₄); oxide of bismuth (BiOx); bismuth oxide (Bi₂O₃); titanium oxide (TiO); niobium oxide (Nb₂O₅); carbon; indium oxide (In₂O₃); indium-tin-oxide (ITO); tantalum pentoxide (Ta₂O₅); ceric oxide (CeO₂); yttrium oxide (Y₂O₃); europium oxide (Eu₂O₃); Fe₃O₄; hafnium nitride (HfN); hafnium carbide (HfC); hafnium oxide (HfO₂); lanthanum oxide (La₂O₃); magnesium oxide (MgO); neodymium oxide (Nd₂O₃); preododymium oxide (Pr₆O₁₁); samarium oxide (Sm₂O₃); antimony trioxide (Sb₂O₃); silicon carbide (SiC; silicon nitride (Si₃N₄); silicon monoxide (SiO); selenium trioxide (Se₂O₃); tungsten trioxide (WO₃); and combinations thereof.

28. The article of claim 25, wherein the surface relief structures exhibit spice reliefs of more than 10 nanometers to less than 3 millimeters in depth and width.

29. The article of claim 25, wherein the coating contains particles to make the coating highly reflective.

30. The article of claim 29, wherein the metallic particles are selected from the group consisting of: aluminum particles; silver particles; gold particles; cobalt particles; chromium particles; platinum particles; palladium particles; nickel particles; cobalt particles; carbon particles; platelets; flakes; dielectric particles; cholesteric liquid crystal polymer particles; magnetic pigment flakes; holographic glitter particles; aluminum oxides (e.g., AL₂O₃); Ce₂O₃; SnO₂; boric oxide (B₂O₃); titanium dioxide (TiO₂); iron oxides (e.g., Fe₃O₄, and Fe₂O₃); zirconium oxide (ZrO₂); zinc oxide (ZnO); zinc sulfide (ZnS); bismuth oxychloride; indium oxide (In₂O₃); indium-tin-oxide (ITO); tantalum pentoxide (Ta₂O₅); ceric oxide (CeO₂); yttrium oxide (Y₂O₃); europium oxide (Eu₂O₃); hafnium nitride (HfN); hafnium carbide (HfC); hafnium oxide (HfO₂); lanthanum oxide (La₂O₃); magnesium oxide (MgO); neodymium oxide (Nd₂O₃); praseodymium oxide (Pr₆O₁₁); samarium oxide (Sm₂O₃); antimony trioxide (Sb₂O₃); silicon carbide (SiC); silicon nitride (Si₃N₄); silicon monoxide (SiO); selenium trioxide (Se₂O₃); tin oxide (SnO₂); tungsten trioxide (WO₃), and combinations thereof

31. The article of claim 25, wherein:
the coating contains metallic particles that accommodate substantially parallel to the surface of the substrate to make the coating more reflective; and
the coating is maintained at a predetermined temperature before curing in order to align the metallic particles substantially parallel to the substrate.

32. The article of claim 25, wherein the surface relief structures are cast or embossed onto the coating in a single pass.

33. The article of claim 32, wherein the coating possesses good release characteristics from an embossing tool.

34. The article of claim 25, wherein the coating interacts with the surface relief structures to create new optical, electric and magnetic effects.

35. The article of claim 25, wherein the coating and surface relief structures are used for an application selected from the group consisting of: (1) currency printing; (2) flexible packaging; (3) rigid packaging; (4) shrink wrap films; (5) labels; (6) security documents such as continuous forms; (7) retroreflective structures; (8) non-reflective structures; (9) online lenticular printing; (10) intelligent substrates such as self cleaning substrates; (11) radio frequency identification products; (12) plastic chips; (13) micro-analysis systems; (14) optical components; (15) medical applications; (16) polymer displays; (17) solar panels; (18) defense applications; and (19) radar invisibility applications.

36. The article of claim 25, wherein the coating has a thickness between 0.1 microns and 3 mm.

37. The article of claim 25, wherein the coating has a minimal difference in refractive index with respect to any adhesives, laminates, inks and/or lacquers that are applied on top of the coating.

38. The article of claim 25, wherein the surface relief structures are applied on a surface of the coating or on a separate ink or lacquers that will be covered with the coating.

39. The article of claim 25, wherein the coating contains metallic particles to create metallizing effects with the surface relief structures.

40. The article of claim 25, wherein the coating contains metallic particles to create semi-transparent and metallizing effects with the surface relief structures, wherein the type of effects is dependent upon the particle density.

41. The article of claim 25, wherein the coating contains particles that are distributed substantially uniformly along a thickness of the coating.

42. The article of claim 25, wherein coating is applied to a substrate selected from the group consisting of films; papers; metals; boards; ceramics; and synthetic papers.

43. The article of claim 25, wherein the coating is applied on top of a metallic coating, a metallic ink, a metallized hot-stamping foil, or a metallized cold-stamping foil.

44. The article of claim 25, wherein the coating is applied to airborne or marine borne vessels in order to impart defense characteristics to these vessels such as radar invisibility.
